(19) United States
(12) Patent Application Publication
(10) Pub. No.: US 2005/0253505 A1
(43) Pub. Date: Nov. 17, 2005

(54) Electronic display device

(76) Inventors: Rogier Johannes Braak, Drachten (NL); Marco Jan Reinder Bron, Drachten (NL); Scott Dale Mclachlan, Amersfoort (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,285

(22) PCT Filed: Feb. 25, 2003
(86) PCT No.: PCT/IB03/00724

§ 371 Date: Aug. 31, 2004

(30) Foreign Application Priority Data
Mar. 6, 2002 (EP) 0205861.1

(51) Int. Cl. H05B 33/24; H05B 33/22

(52) U.S. Cl. 313/506; 313/512; 313/503

(57) ABSTRACT

An electronic display (2) device comprising: a polymer LED display (8); a filter layer (11); a semi-transparent reflective layer (12) covering said filter layer (11) for transmitting light (14) emanating from said polymer LED display and for reflecting ambient light (13) incident on said semi-transparent reflective layer so as to obscure electrical connections for exciting said polymer-LEDs. Due to the reflective properties of the semi-transparent reflective layer (12), graphics of the polymer LED are hidden while the brightness of the display is maintained to a sufficient degree.

The invention relates to an electronic display device comprising: a polymer LED display comprising a geometrical arrangement of individually excitable polymer LEDs for forming an image, and comprising electrical connections for exciting said polymer LEDs; and a light-absorbing filter layer covering said display.

Recently, progress has been made in manufacturing this type of display device, which offers a cost-effective substitute for traditional display devices, such as LCD screens or other types of screens. These polymer LED displays exhibit a two-dimensional structure of LEDs which are electronically controlled by electrodes that are configured to connect to the pixel positions. The electrodes and peripheral electronic connections form a visible structure in said display that is distracting for a person reading out said display. Therefore, a need exists to conceal said visible structure, while at the same time maintaining a sufficient brightness of the polymer LED display when in use.

In the art, filter layers have been applied with filtering properties sufficient to hide the underlying graphics of the polymer LED display and with transmitting properties for transmitting a sufficient amount of light from the polymer LEDs, in order to achieve a brightness of the display.

However, no sufficient concealment was reached without undue attenuation of light emanating from the polymer LED display. Besides, when filter layers with insufficient absorbing properties were applied, the graphics remained discernible. Therefore, due to a relatively strong light absorption in the intermediate filtering layer, the known polymer LED display has quite weak brightness properties, and a desire exists to improve the readability properties of current polymer LED displays.

The above-mentioned object is solved by a display device according to the characteristics of the preamble, wherein a semi-transparent reflective layer covers said filter layer for transmitting light emanating from said polymer LED display and for reflecting ambient light incident on said semi-transparent reflective layer, so as to obscure said electrical connections for exciting said polymer LEDs. When in use, the reflective layer is in a transmissive mode, while, when not in use, the color filter provides a dark background, thus enhancing the reflective properties of the layer. Due to the reflective properties of the semi-transparent reflective layer, the graphics of the polymer LED are hidden while the brightness of the display is maintained at a sufficient level.

In a further embodiment, the said semi-transparent reflective layer is a reflective polarizing layer. In this embodiment, the losses in the reflective layer due to light absorption are kept optimally low. Such a polarizing layer is known per se from, for example, U.S. Pat. No. 6,053,795.

In a further advantageous embodiment, said polymer LED display device, said color filter, and/or said semi-transparent reflective layer are coupled via an anti-reflective coating. Such coatings generate a higher light yield by optimizing the transmission of light between the consecutive layers.

In practical experiments, especially good results were achieved when a brightness-enhancing layer manufactured by 3M Company of St. Paul, Minn. under the trade designation “DUAL BRIGHTNESS ENHANCEMENT FILM” was provided as a semi-transparent reflective layer.

It is noted that this layer, referred to as 3M-DBEF film below, is a light enhancement layer which is typically used in connection with a LCD-layer in an LCD-screen. In such LCD-screens, the LCD-layer is often illuminated by an electroluminescent light source emitting generally unpolarized light and situated at the back of the LCD-layer. The 3M-DBEF layer is a reflective polarizing layer, which reflects the light of the undesired polarization state back into an electroluminescent light source. The electroluminescent light source provides a recycling effect, wherein the light reflected back from de DBEF layer into the electro-luminescent source is returned as light of a generally unpolarized state. This light is again incident on the polarizing 3M-DBEF, thereby increasing the fraction of transmitted light having a correct polarization state. In the electronic display device according to the invention, the reflection of ambient light by this 3M-DBEF layer is quite different from the normal use of this film material, when light emitted by a back-light is reflected by the 3M-DBEF layer. Furthermore, from U.S. Pat. No. 6,053,795 discloses a configuration with an electro-luminescent light covered by a color filter and a reflective polarizer such as the above-mentioned 3M-DBEF layer. However, this disclosure is not concerned with polymer LED displays. Furthermore, the disclosure describes the use of twofold layers of polarizing filters, wherein a reflective mode is achieved when the two polarizing layers have a predetermined orientation towards each other.

Further advantages and features will become apparent when reading the description in connection with the drawings, In the drawings:

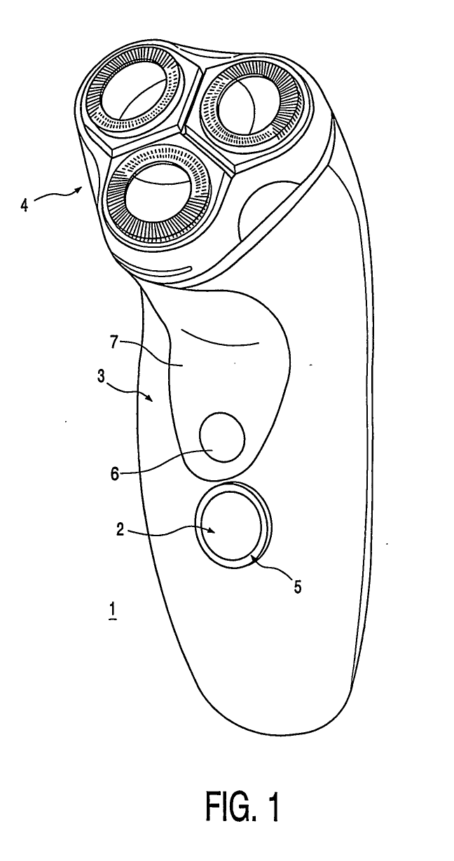

FIG. 1 is a perspective view of an electronic device comprising the display according to the invention.

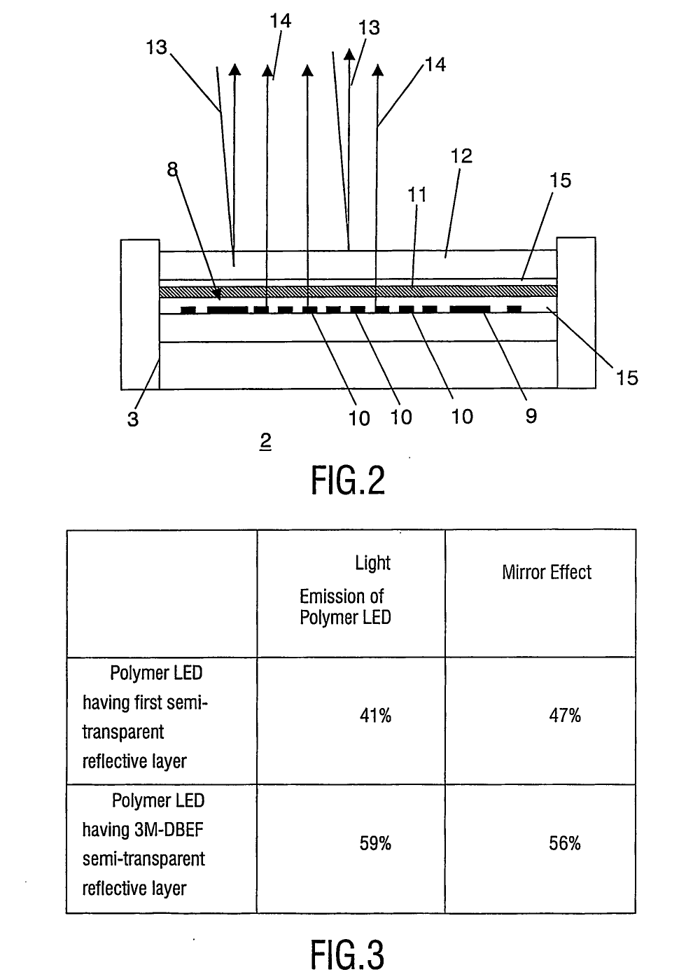

FIG. 2 is a diagram of a polymer LED display according the invention, having a semi-transparent reflective layer.

FIG. 3 is a Table with test results of two embodiments of the invention.

FIG. 1 shows an electronic shaver 1 equipped with the display device 2 of the invention. The shaver is a hand-held appliance comprising a synthetic housing 3 accommodating three razor heads 4. In the housing 3, an opening 5 is provided in which the display device 2 is watertightly sealed. The shaver is further provided with a control switch 6 located behind a flexible panel 7 for turning the shaver on or off. In the off-states, the display device 2 is visually seamlessly integrated in the wall of the appliance 1, in the on-states, the display device 2 can be read out in order to identify a battery status and/or current working status of the appliance 1. As a non-limitative example, the display-device may be contained in other, preferably hand-held appliances, such as mobile phones, gaming devices, etc.

In FIG. 2, a schematic arrangement is shown of the electronic display device 2 according to the invention. The display device 2 has a housing 3 comprising a polymer LED display 8. On the polymer LED display 8, functional information may be indicated in the form of graphics/text etc., such as a battery status, time, etc.

In the housing 3 (not shown), various electronic components are comprised for control and power supply of the polymer LED display 8. The polymer LED display comprises electronic connections, such as electrodes 9, connecting the individually excitable polymer LEDs 10, which form a geometrical configuration on the polymer LED display 8. In order to conceal these electronic connections 9, the polymer LED display 2 according to the invention further comprises a light-absorbing filter layer 11 covering said polymer LED display 8, for filtering a selected range of light emanating from said display. Said filter layer 11 provides a relatively dark, light-absorbing background which, in combination with a semi-transparent reflective layer 12 covering said filter layer 11, forms a reflective mirror which impairs a view of the interior of the display device 2. When not in use, the display device 2 will look like a mirror, reflecting ambient light 13 that is incident on said semi-transparent reflective layer 12.

When the polymer LED display 8 is in use, i.e. when an image is formed on the display 8, the semi-transparent reflective layer 12 will transmit light 14 emanating from said polymer LED display 8.

For reduction of losses, preferably, the semi-transparent layer 12 is a reflective polarizing layer, reflecting light polarized in a first direction and transmitting light polarized in a second direction oriented substantially orthogonal to said first direction. Further, preferably, said polymer LED film device 8, said color filter 11, and/or said semi-transparent reflective layer 12 are coupled via an anti-reflective coating 15.

In FIG. 3, test results are given for the reflective and transmissive properties of two embodiments of the invention. Four tests were performed.

In a first test, the transmissive properties of a semi-transparent layer were tested, wherein the layer consisted of a thin metal film deposited on a transparent substrate. This transmission was tested by measuring the light output of the polymer LED in the presence and absence of semi-transparent reflected layer 12. The transmission of the first embodiment of the electronic layer is 47%.

Then, the transmissive properties were tested in a second test, where the semi-transparent layer used was a brightness-enhancing layer manufactured by 3M Company of St. Paul, Minn. under the trade designation “DUAL BRIGHTNESS ENHANCEMENT FILM”. Surprisingly good results were obtained with this special film, the transmission in this second embodiment was found to be significantly higher, up to 59%.

Likewise, the reflective properties of the display device 2 were tested, comparing the results of the first embodiment and the second embodiment. Again, the reflective polarizing film of 3M turned out to have especially good reflective properties as compared with the embodiment comprising a thin metal film layer.

It will be clear to those skilled in the art that the invention is not limited to the embodiments described with reference to the drawing but may comprise all kinds of variations thereof. These and other variations are deemed to fall within the scope of protection of the appended claims.

1. An electronic display device comprising:
a polymer LED display comprising a geometrical arrangement of individually excitable polymer LEDs for forming an image and comprising electrical connections for exciting said polymer LEDs; and
a light-absorbing filter layer covering said display; the display device further comprising:
a semi-transparent reflective layer covering said filter layer for transmitting light emanating from said polymer LED display and for reflecting ambient light incident on said semi-transparent reflective layer, so as to obscure said electrical connections for exciting said polymer LEDs.

2. An electronic display device as claimed in claim 1, characterized in that said semi-transparent reflective layer is a reflective polarizing layer.

3. An electronic display device as claimed in claim 1, characterized in that said polymer LED display, said light-absorbing filter, and/or said semi-transparent reflective layer are coupled via an anti-reflective coating.

4. An electronic display device as claimed in claim 1, characterized in that the semi-transparent reflective layer is a brightness-enhancing layer manufactured by 3M Company of St. Paul, Minn. under the trade designation “DUAL BRIGHTNESS ENHANCEMENT FILM”.

5. An electronic appliance comprising an electronic display as claimed in claim 1.

6. An electronic appliance as claimed in claim 5, characterized in that it comprises an electric shaver.
